(19) United States
(12) Patent Application Publication
(10) Pub. No.: US 2012/0286131 A1
(43) Pub. Date: Nov. 15, 2012

(54) UNIVERSAL CANOPY SUSPENSION SYSTEM

(76) Inventor: FRANK STEELE ARNOLD, III, BROOKHAVEN, MS (US)

(21) Appl. No.: 13/467,545

(22) Filed: May 9, 2012

Related U.S. Application Data
(60) Provisional application No. 61/518,624, filed on May 9, 2011.

(51) Int. Cl. F16M 13/02

(52) U.S. Cl. 248/674; 248/534

(57) ABSTRACT

A suspension system for the attachment of a multiple bladed fan, connected beneath the roof of a canopy-styled tent or other overhead structure. The system's bracket is comprised of multiple arms that universally grip the frame of the said canopy-styled tent or overhead structure. Suspension is not limited to a fan, but also other embodiments, each powered by a plug or battery. The bracket is manufactured in polymer or like material. The system's fan blades are comprised of foam, rubber, or other soft matter. The suspension system allows the fan or other attached embodiment's height to be manipulated by a process further shown in this application. The system further includes embodiments for lighting, heating, or the mounting of additional embodiments. The suspension system and its embodiments are portable and may be broken down into a self-contained bag or case for easy transport.

### CROSS-REFERENCE TO RELATED APPLICATIONS

This application claims the benefit of my previously submitted utility PPA, Application No. #61/518,624, with Filing or 371(c) date of May 9, 2001.

### FIELD OF INVENTION

This application relates to the use of an attachable fan and its embodiments to an outdoor canopy-styled tent.

### BACKGROUND OF PRIOR ART

Canopy-styled tents have multiple legs, a roof, and sometimes side walls. They have been used for hundreds of years as shelter; however, they are limited in providing comfort and protection for the individual user from the outdoor elements such as extreme temperatures or poor lighting. Another problem is that some current products do not free up the user to perform other tasks while enjoying the climate-controlled atmosphere. For example, battery powered hand-held fans are currently available for purchase. Some of the hand-held fans are inexpensive and safe, yet they do not easily solve this problem. There are currently free standing fans such as a box-styled fan or an industrial fan that can be used with tents; however, they are noisy and cumbersome to deal with. These fans also are level with the user and do not provide top-down air flow. Another available option is a pedestal fan. These fans are heavy and hard to transport and get in the way of the user's activities. There are also attachable tent fans on the market, but they are either small and do not provide adequate air flow or larger in size but too heavy to be installed on smaller canopy-styled tents with thin poles. Sure, there are tent companies out there that can set up for large events and use these large tent fans; however, most of the types of individually-owned canopy-styled tents are small and use thin poles that cannot support the weight of these large attachable fans. These types of fans also because of their weight and size cannot be connected to a pole that is not level due to the slope of the ground in which is erected. This limits the use of these types of fans. Another problem with the above-mentioned fan options are the material in which they are made. The fans use either plastic or metal blades. This makes these fans dangerous in use and non-weather resistant. The issue of cleaning is also difficult with box and industrial fans. Sometimes, a screwdriver is needed to open the grill of a box or commercial fan to properly clean dust and grime collected during operation. This can be dangerous and the risk of shock exists. The weight of these attachable fans to the ceiling of a canopy-styled tent makes it risky to attempt attaching. In addition, most ceiling fan blades are constructed of wood, plastic, or metal and can be very dangerous if a user came into contact with a spinning blade. All canopy tents are not created alike. There is the issue of height adjustment that must be taken into consideration for proper air circulation and safety. If a ceiling fan was put in a canopy tent, and the like structures, adjustment of fans height would be difficult. These units are stationary once installed and cannot travel from place to place and be quickly set up for use. Attaching a fan or an apparatus to hold it in position beneath a canopy tent is an issue. Lastly, these fans are just that, only a fan. There is no way to interchange the components of any of these fans to provide lighting or heating within the same attachable system. Separate products would have to be purchased.

### SUMMARY OF INVENTION

The advantage of the Universal Canopy Suspension System is that it provides comfort to the user of any canopy-styled tent from the outdoor elements (cold temperatures, hot temperatures or darkness) with ease and simplicity. This system provides the user with the ability to perform other activities while enjoying a climate-controlled environment. The system is easy to transport, going from an easy-to-tote bag to installation in minutes. It is not heavy but large enough to provide adequate top down air-flow or evenly distributed heat as well as plentiful lighting. The suspension system is able to provide lighting and heating instead of or in combination with the fan. Its blades for the fan are made of a foam, or like materials which makes it safe, durable, and weather resistant. A latex dipping process keeps my prototype's blades stiffer which provide better air flow. My blades are not limited to foam with a latex cover, similar production options are presently being explored including injection molding and sprayed on finishes. The Universal Canopy Suspension System and its embodiments also function properly and easily attach to the largest canopy-styled tents as well as those smaller canopy-styled tents with thin poles that are used for recreational purposes, even if the ground on which the canopy-styled tent is to be erected is uneven. It is quiet and out-of-the-way of the participants, freeing them to enjoy activities with comfort and convenience. My Universal Canopy Suspension System also has the ability to be manufactured and shipped to user complete with their blade color of choice I am exploring the idea for the user to have the ability order and change his/her blades without compromising the fan's weather resistant characteristic. This method of exchange will be safe, simple, and quick. This will also give the user the ability to replace a damaged blade. Another advantage of the Universal Canopy Suspension System is simple cleaning By quickly removing the fan from the canopy pole(s), a user is in a better position to clean the fan safely and efficiently. A damp rag across the entire surface of the fan can be quickly performed after each use. Having the ability to unplug the fan from its power source prior to cleaning alleviates the risk of shock. The extra step of ladders and other means for removing the suspension system can be avoided by the ability of some canopy-styled tents to adjust its leg length to lower its canopy or roof can also be avoided. Screwdrivers or similar devices used for the removing of a fan's cover to clean is also avoided with my Universal Canopy Suspension System. The latex, or like material, covering the blades prevents dirt and finger prints being embedding to the porous blade's surface. Current design and manufacturing changes to make my Universal Canopy Suspension System and its embodiments battery powered are being explored. Types of batteries to meet our needs of RPMs and extended battery life are available on the market. Finding one to meet those exact needs are a challenge.

Operation

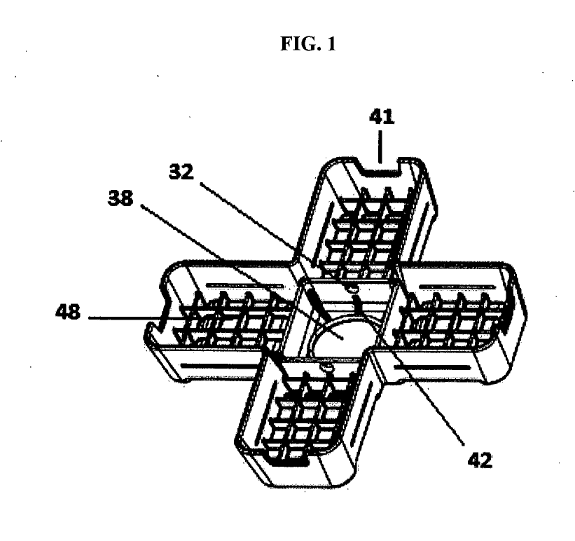

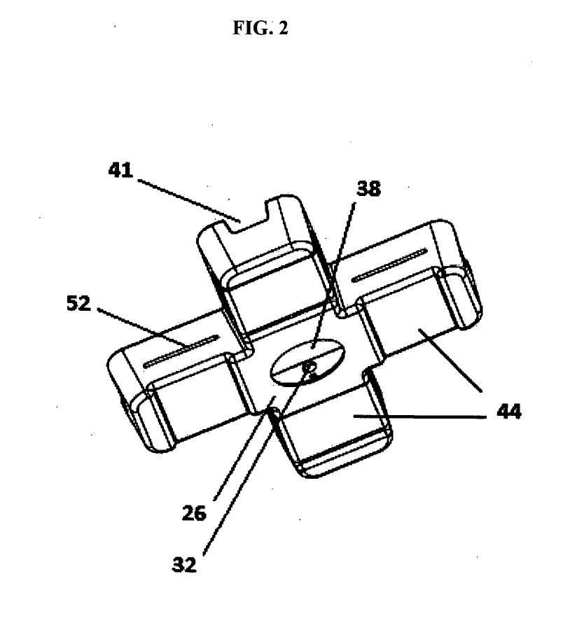

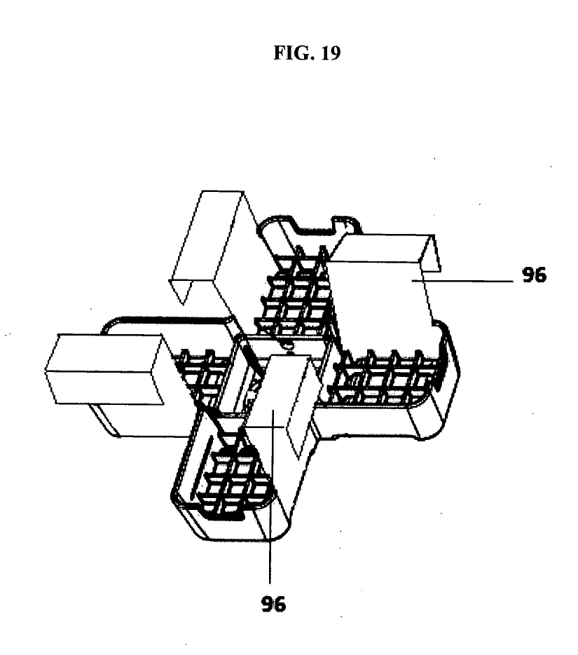

The first step in using Universal Canopy Suspension System is to find a canopy-styled tent where a user of my system and its embodiments would benefit. The canopy-styled tents that I have testing and completed prototypes for are the 10′×10′ and 20′×10′ pull out and pop up, or collapsible canopy-styled tents with 4 or 6 adjustable legs. However, connection with my Universal Canopy Suspension System's attachment bracket a larger canopy-styled tents with fixed multiple legs, has proven to be successful. Proper function of the motor, blade, bulbs, and heating element embodiments will need to be further explored to adjust their sizes for maximum user benefits. The action steps for erecting a collapsible canopy-styled tent is represented in detail in Drawings 2-6 on my drawing sheets. After the canopy-styled tent's canopy or cover is up and fully expanded, the user may begin the Universal Canopy Suspension System's set up. An embodiment needed for the Universal Canopy Suspension System's fan, light, or heating connection is an attachment bracket 26, as illustrated in FIG. 1 (a top view) and FIG. 2 (a bottom view). This attachment bracket consists of multiple arms and is manufactured by polymer or like material. The bracket is lightweight, but strong. Its integrity is enhanced by a waffle patterned 48 reinforcement ridges arms. The bracket 26 has an oval hole 38 cut out at its base. This hole is designed to hold a drop down rod 40 that can connect to a fan 34, light 70, heater 97, television mounting system, extension pole 18, and future connecting embodiments being explored. The bracket 26 can either be attached with hook and loop straps threaded through the arm slits 52, attached with arm hooks seen in FIG. 19, or attached in other similar methods. Once the downrod 40 is inserted into the oval hole 38, a pin 33 can be threaded through the holes in the attachment bracket 32 and the holes 43 in the drop down rod 40, and locked into place with a pin/clip. Each arm of the bracket needs to be prepared for attachment to the tent pole(s). Therefor the user must thread each of the hook and loop straps through the slits in each arm of the bracket (see Drawing 7). At this point, the attachment bracket 26 is pushed up towards and against the tent's canopy poles. Make sure that the canopy poles lie within the u-shaped cut outs 41 for a tighter and closer connection. With the hook and loop straps connect the bracket 26 to the canopy's poles (this process is shown in Drawings 7-10) and pull until tight. Once the bracket 26 is attached, the drop down rod 40 is ready to connect to a number of embodiments: a fan 34, an optional light 70, a heater 87, extension pole 18, or future embodiments.

The fan 34 connects to the down rod 40, by incursion of the said down rod 40 into the top female cap of the fan 23 and locked into place with a double button snap. To decrease the height of the fan an extension pole 18 can be attached between the down rod 40 and the female cap 20 on top of the fan. The blades 28 of the fan 34 are made of shaped foam dipped in latex. Sure this is not the only way to make these blades 28, but this process worked well for our prototypes. The blades 28, attached to a blade wheel 56, are thick enough and rigid enough to keep their shape and provide efficient airflow. At the base 54 of the fan 23 can also have a light. The fan and light can be controlled via the remote control 92. This and additional embodiments are powered by normal US extension cords or socket 58 or by an optional battery.

The attachment bracket 26 can also connect to an optional light 70 via the same attachment process, however the downrod 40 will connect to an extension pole 18 or directly into the female cap 73 located on the top of the light.

The attachment bracket 26 can also connect to an optional heater 87 via the same attachment process; however, the downrod 40 will connect to an extension pole 18 or directly into the female cap 90 located on the top of the light.

To turn these embodiments any direction, I am exploring a hinge option 94. The hinge will allow the light 70, heater 87, television, and future designed functional devices the ability to point the Universal Canopy Suspension System's connected embodiment toward the user.

There is not just one way to connect my Universal Canopy Suspension System's bracket: ropes, tape, bungee cords, pin and clips, and the like are a few options. My goal is to make the bracket and its snap on embodiments simple to assemble and functional. FIG. 19 is another very simplistic method of design and connection of the bracket. The arms on each of the attachment bracket each have a hook on each arm. These hooks are similar to the Christmas wreath holders that can be installed above the door of a house. There are four hooks in FIG. 19; however there could be only one, two or more. This design of the Universal Canopy Suspension System's bracket allows the user to simply push the four hooks of the attachment bracket between the poles and up towards the canopy. Once the base of the hooks are above the canopy's poles, twist the attachment bracket (counter clockwise with this CAD design) until the bracket is stopped by the canopy's poles. At this point the hook should be aligned so that one may release or pull down on the bracket locking it into place. This is a much easier method and keeps the hook and loop threading out of the picture. This design is to be further explored, but I feel it is a viable design option for my Universal Canopy Suspension System's bracket. As far as the drop down pole with ball joint, its locking mechanism, the oval 18 and arm integrity ridges 48, I do not see a need for design altering at this point. The attachment bracket will connect faster to the canopy's poles and hold the bracket and its connected embodiment without issues.

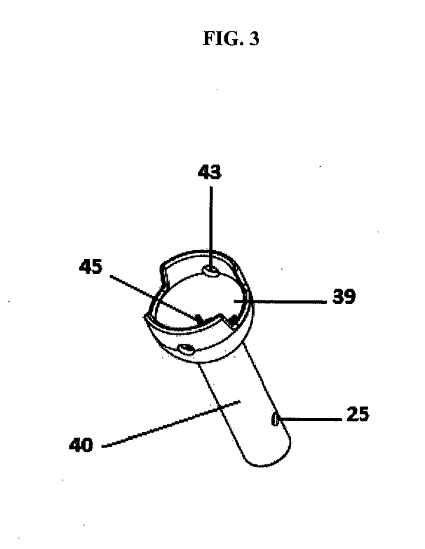

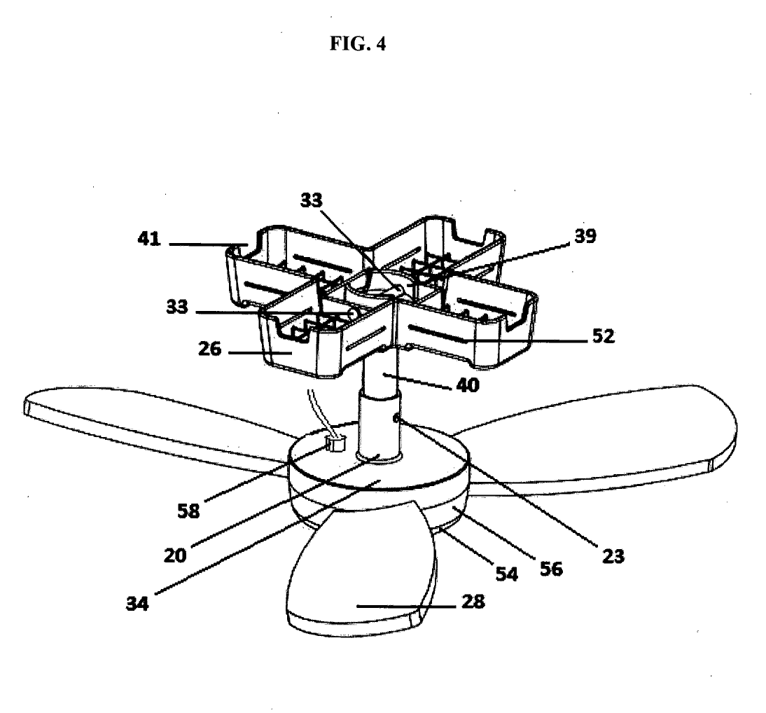

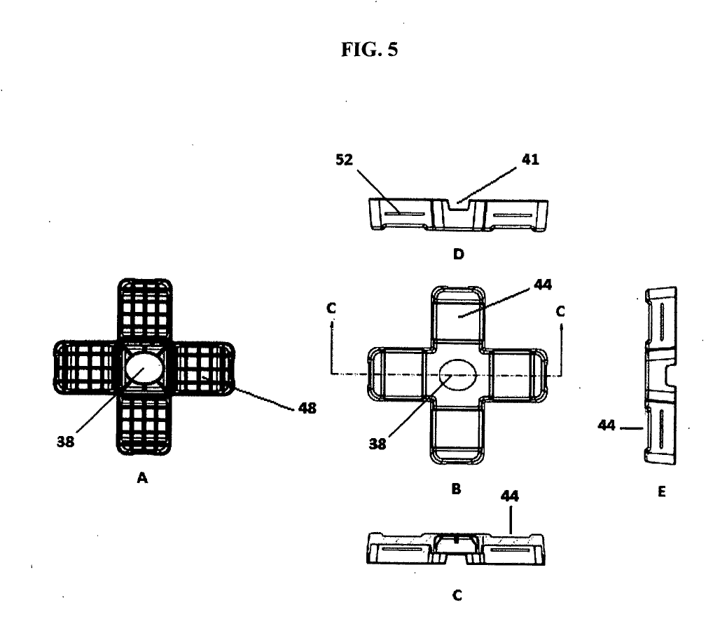

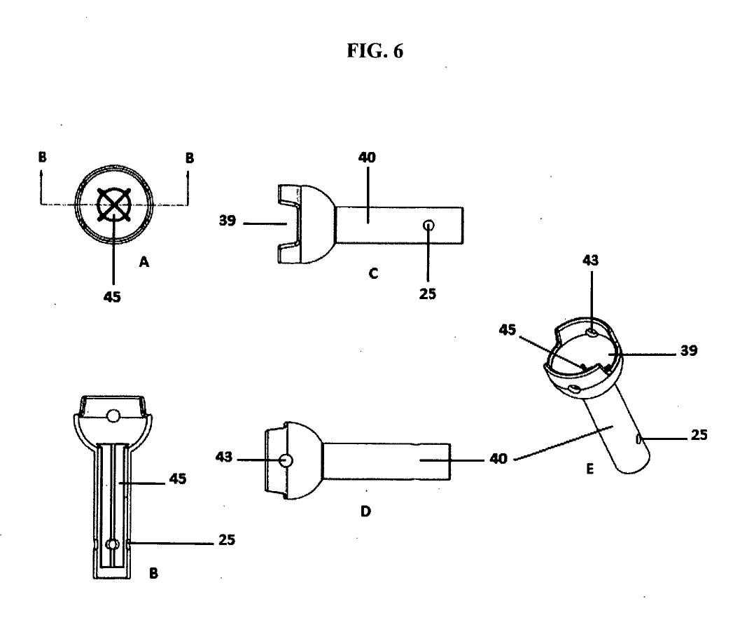

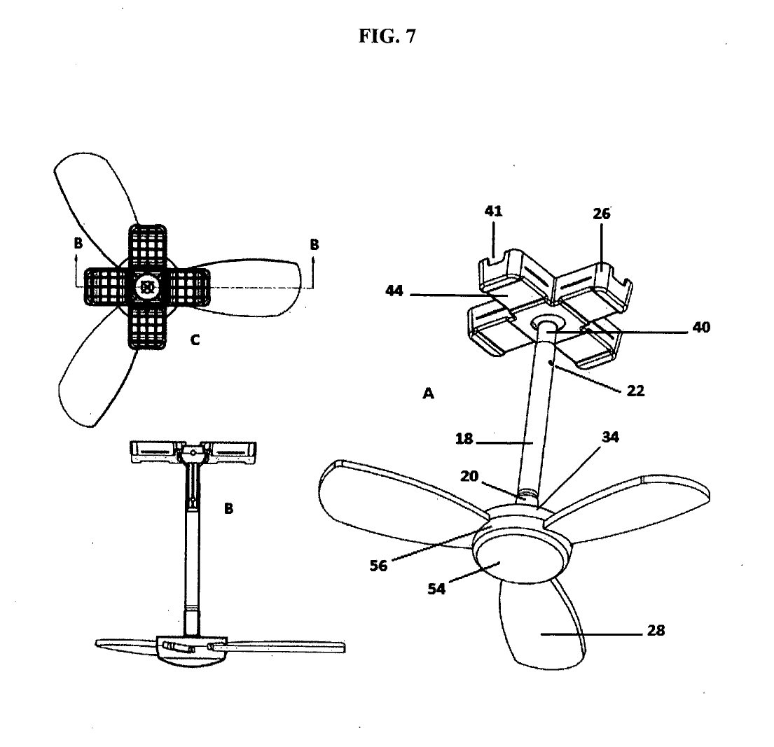

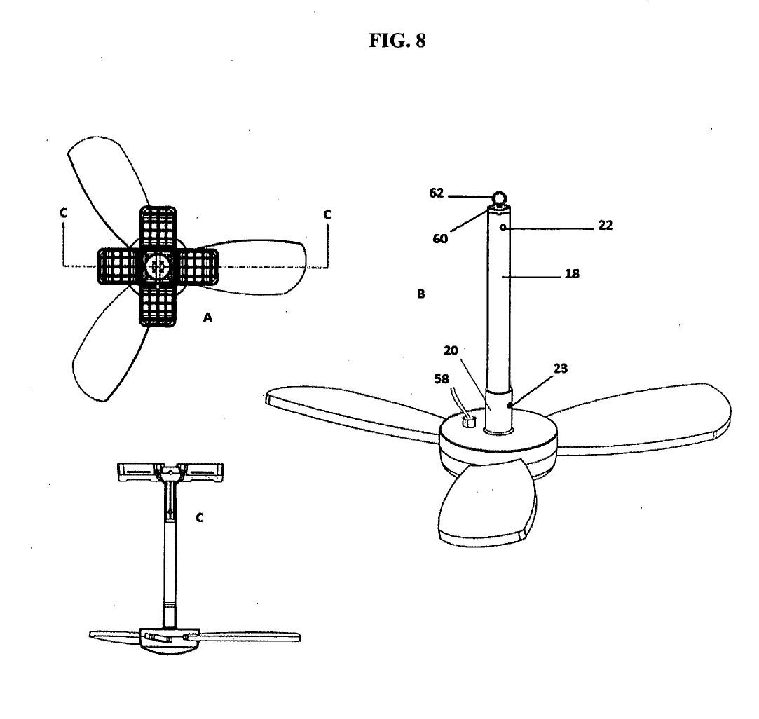

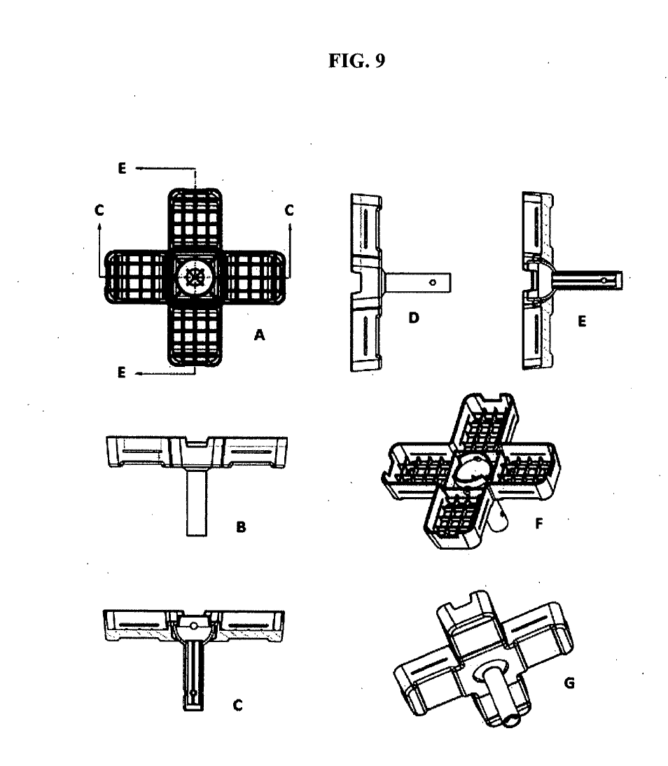

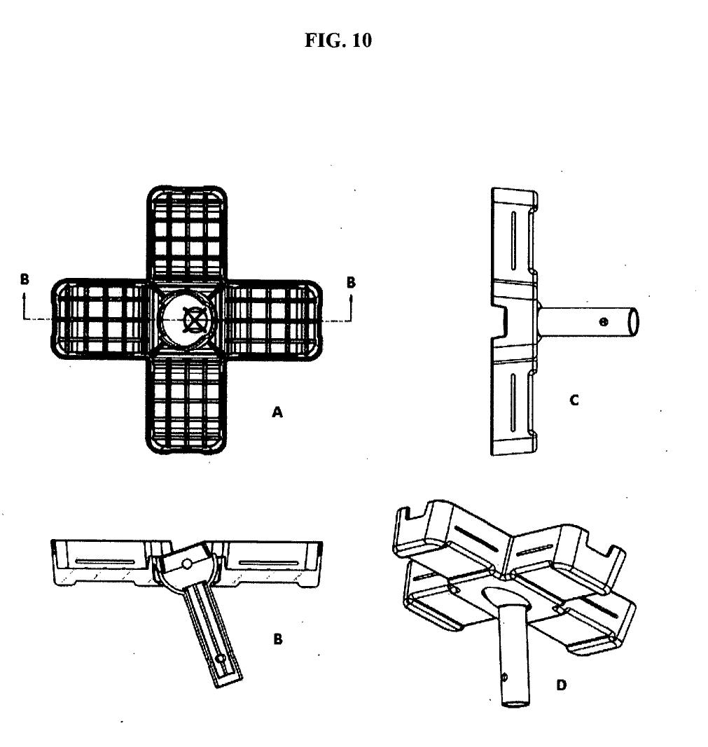

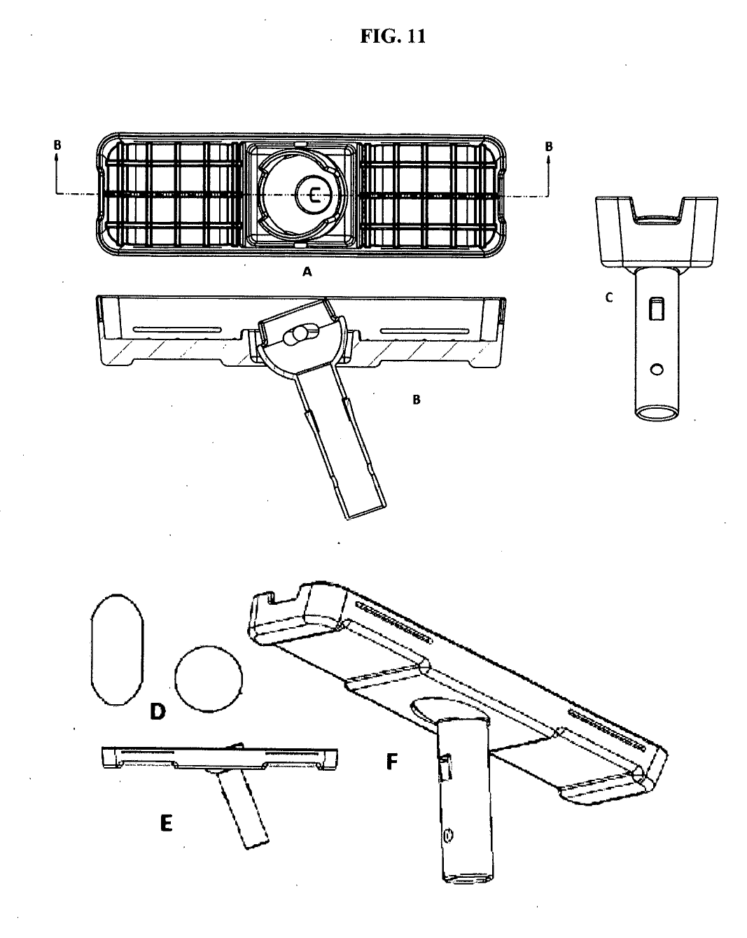

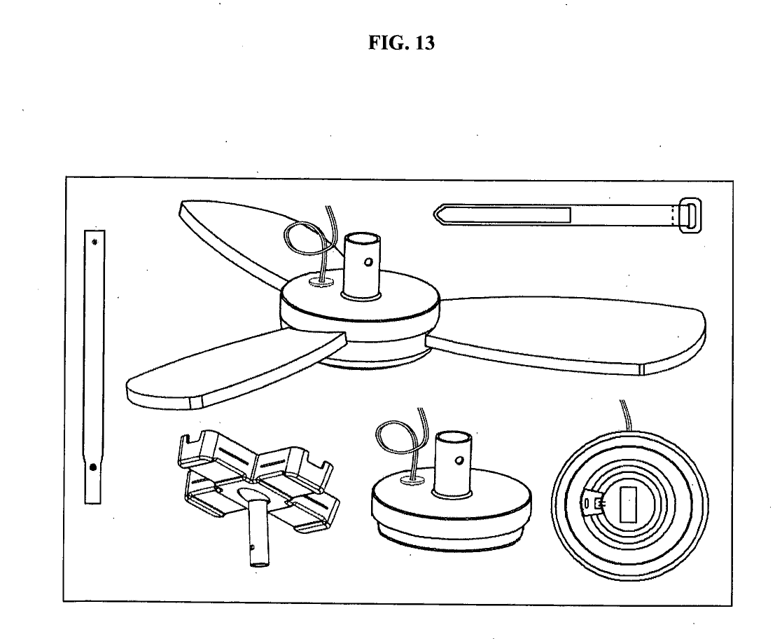

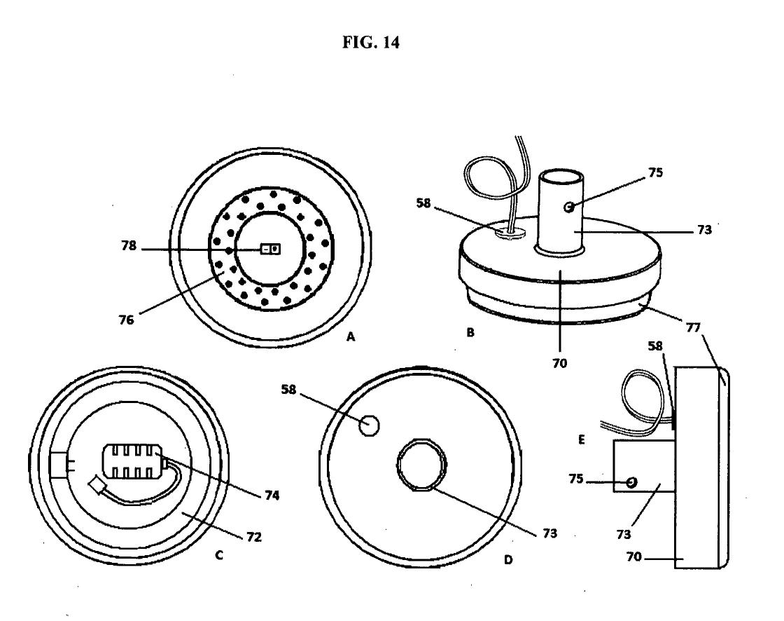

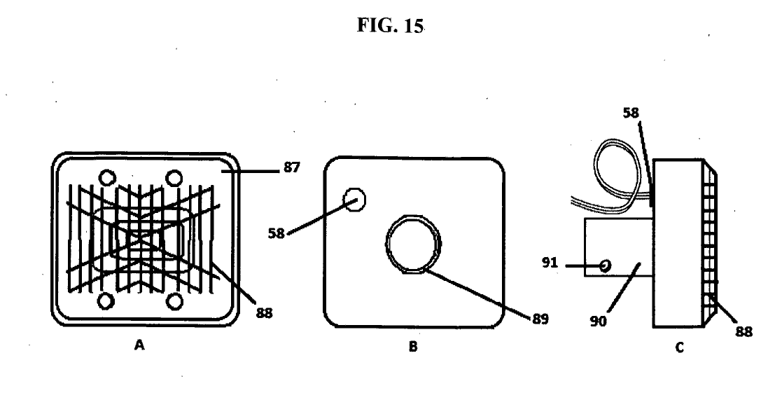

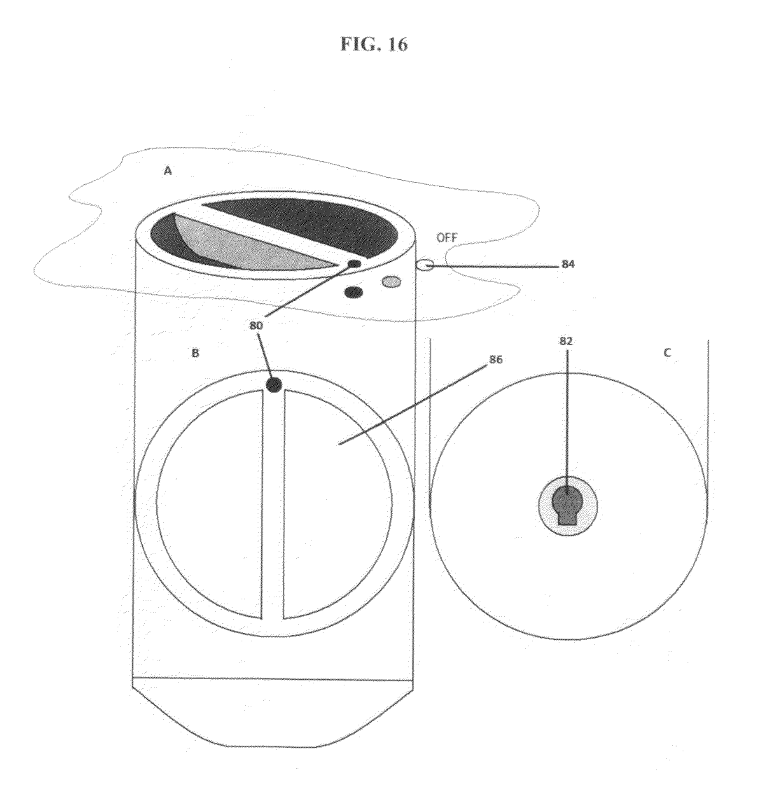

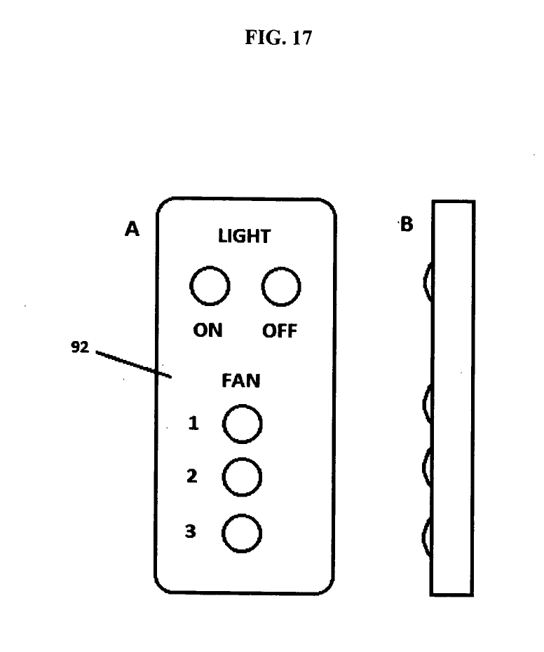

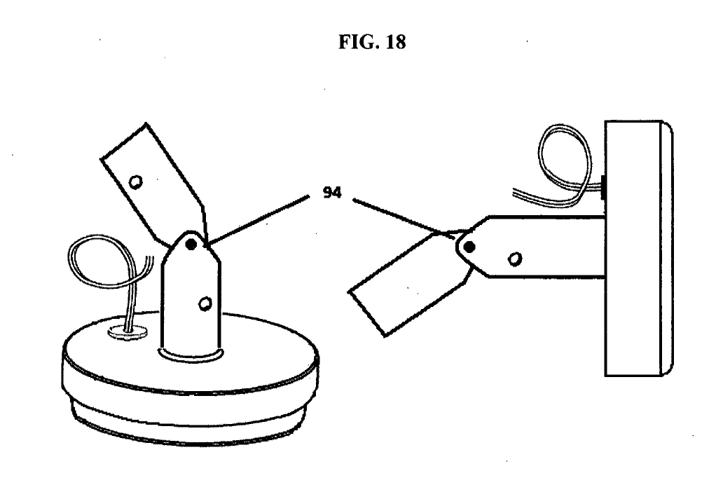

### FIGS. 1-19 REFERENCE NUMBERS AND BRIEF DESCRIPTIONS

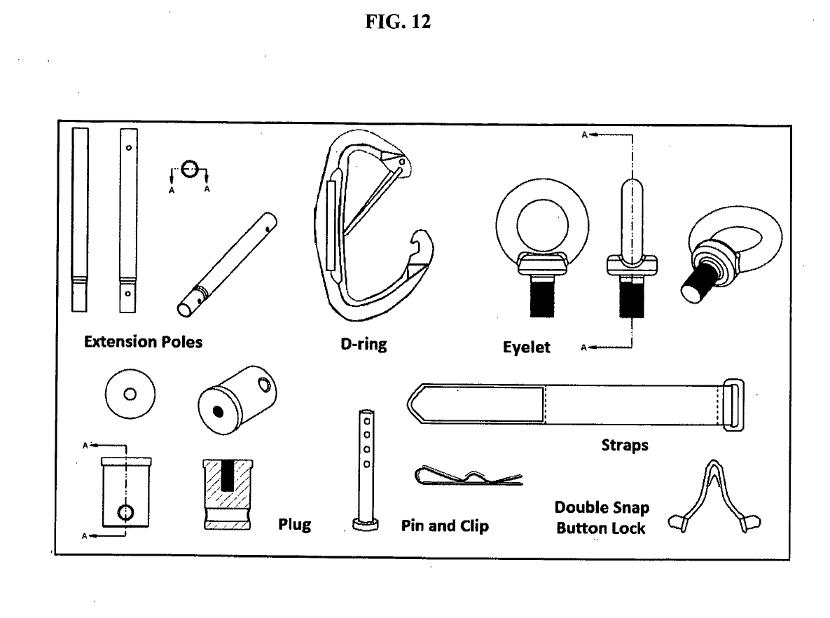

18 extension pole for height adjustment
20 motor housing unit's universal female cap, connects to extension pole or directly to the downrod
22 extension pole's hole for the double locking button snap, attaches to downrod or pin and clip with a ceiling plug
23 hole in motor housing unit's female cap for double locking button snap, pin and clip, or other locking mechanism
25 downrod's hole(s) at the base of ball joint that allows double locking button snaps to connect directly to an attachment pole or to the female cap of fan, light, or heater
26 attachment bracket
28 “soft to the touch” blade made from flexible foam and latex or similar materials that allows shaping and bending without breaking
32 attachment bracket's hole for security pin insertion
33 security pin and clip (clip not shown) inserted through the ball joint and downrod of attachment bracket
34 upper housing unit for motor
38 downrod's oval hole
39 cut out to allow swinging of downrod without intrusion against the canopy tent's upper poles
40 downrod (male part) that connects to motor housing unit, optional light, optional heater, or extension pole
41 attachment bracket arm's U-shaped cut outs offering a closer fit to the canopy tent's poles
42 support ridges around oval downrod hole, adds structural integrity when fan, light, or heater is attached
43 security pin hole for additional safety; security pin goes through bracket and ball joint and locks with pin
44 attachment's indentions or track to keep hook and loop straps from shifting
45 interior downrod integrity ribs
48 attachment bracket's “waffle” ribs for structural integrity
52 cut outs for hook and loop straps or similar material for connection to the canopy tent's poles
54 base fan can be flat or has lighting capabilities with, LED, florescent, or similar lighting devices
56 fan's blade wheel; note: no protruding screws or an edge in case the user makes contact with the blade
58 fan, light, or heater power source if not using battery
60 plug (see Drawings 23, 24) allows fan, light, or heater to connect elsewhere than a canopy tent; use of plug, eyehook, and a d-ring (see FIG. 12) allows a properly functioning fan if hung from a level or sloped pole, tree limb, ceiling, rafter, etc.
62 plug's eyehook
70 optional light
72 optional light with round florescent bulb, or like mechanisms
73 optional light's female cap for connection to either extension pole or directly to the attachment bracket
74 florescent bulb ballast
75 hole in female cap for double button lock, pin and clip, and similar mechanism
76 optional light with LED bulbs or like mechanisms
77 globe or cover for the optional lighting system; can also be flush with no electronics
78 light's on/off switch; many switch options are available
80 fan's dial or knob notification dot
82 back view of dial or knob
84 notification dots
86 fan or light dial, there are many options for knob design
87 optional heating system
88 protective grill over heating element
89 optional heating system's upper female cap for connection to extension pole or directly to attachment bracket's downrod
90 optional heating system's female cap hole for double button snap, pin and clip, or similar mechanism
92 remote control
94 hinge
96 optional hook attachments

1. I claim a device or bracket for attaching a connection apparatus to the support pole(s) beneath the upper roof or canopy of a collapsible or non-collapsible canopy-style tent, comprising.
a: Providing an elevated multi armed attachment bracket with the ability to grip the said
b. support pole(s) beneath the said canopy-styled tent's roof, cover, and the like.
c. Threading or wrapping hook and loop straps, tape, rope, bungee cord, or other connecting materials, through or around the said attachment bracket arms to secure to the bracket to the said support pole(s) beneath the said canopy-styled tent's canopy or roof.
d. Hanging the attachment bracket from the said support pole(s) beneath the said canopy-styled ten's roof or canopy by pushing the bracket over the said support poles, twisting and then dropping the said bracket thus locking it into place

2. The device or bracket of claim 1 comprises a device for the attachment of an operational, fan, light, heater, television mounting system, medical equipment, and like embodiments mounted above and out of the way of a user via dropdown rod, hook, pin and clip, and like embodiment with connecting abilities extending from the said device or bracket.
